(19) United States
(12) Patent Application Publication
(10) Pub. No.: US 2025/0276280 A1
(43) Pub. Date: Sep. 4, 2025

(54) HIGH-PRESSURE AIR CARBON ADSORPTION AND DESORPTION INTEGRATED DEVICES APPLIED TO INTELLIGENT GREENHOUSE

(71) Applicant: CHANGZHOU UNIVERSITY, Changzhou (CN)

(72) Inventors: Yi ZHANG, Changzhou (CN); Jiahao LIN, Changzhou (CN); Wenjian LUO, Changzhou (CN); Meng YAN, Changzhou (CN); Yimang LI, Changzhou (CN); Qi MENG, Changzhou (CN)

(73) Assignee: CHANGZHOU UNIVERSITY, Changzhou (CN)

(21) Appl. No.: 19/209,850

(22) Filed: May 16, 2025

Related U.S. Application Data
(63) Continuation-in-part of application No. PCT/CN2022/142816, filed on Dec. 28, 2022.

(30) Foreign Application Priority Data
Nov. 29, 2022 (CN) 202211507455.3

(51) Int. Cl. B01D 53/62; B01D 46/00; B01D 53/34; B01D 53/82; B01D 53/96

(52) U.S. Cl. CPC B01D 53/62; B01D 46/0036; B01D 53/346; B01D 53/82; B01D 53/96; B01D 2253/102; B01D 2253/108; B01D 2257/504; B01D 2258/06; B01D 2259/40096

(57) ABSTRACT

A high-pressure air carbon adsorption and desorption integrated device applied to an intelligent greenhouse is provided, including a first air compressor, a first adsorption column, a second adsorption column, and a vortex blower exhaust pump connected sequentially. A second air compressor is connected to bottoms of the first adsorption column and the second adsorption column. A plurality of groups of adsorption assemblies are arranged at intervals within each of the first adsorption column and the second adsorption column, each group of the plurality groups of adsorption assemblies includes two adsorbent placement plates, a heater is arranged between the two adsorbent placement plates, each group of the plurality groups of adsorption assemblies is provided with a plurality of through-holes, and each of the plurality of through-holes is arranged with an openable and closeable variable pressure blade.

### CROSS-REFERENCE TO RELATED APPLICATIONS

This application is a continuation-in-part of International Application No. PCT/CN2022/142816 filed on Dec. 28, 2022, which claims priority to Chinese Application No. 202211507455.3 filed on Nov. 29, 2022, the entire contents of each of which are hereby incorporated by reference.

### TECHNICAL FIELD

The present disclosure relates to a carbon capture technology field, and in particular, to a high-pressure air carbon adsorption and desorption integrated device applied to an intelligent greenhouse.

### BACKGROUND

In greenhouse planting, in order to enhance crop yield, it is usually necessary to regularly or irregularly introduce air containing carbon dioxide into the greenhouse, on one hand, a temperature in the greenhouse can be increased, and on the other hand, the carbon dioxide as a raw material for photosynthesis can promote crop photosynthesis and plant growth, thus increasing plant production.

Generally, a large amount of high-pressure air is continuously passed into the adsorption column to utilize the adsorbent to react with the air to capture the carbon dioxide in the air, and then the adsorbed carbon dioxide is released and passed into the greenhouse. Because the carbon dioxide content in the same air is 330 mg/L, and the carbon dioxide content is relatively low, if the air flow rate passed into the adsorption column is too slow, even if the air reacts sufficiently with the solid adsorbent, the trapping time is too long, resulting in a poor effect that cannot achieve the expected results. Therefore, it is necessary to operate under the premise of a relatively high-pressure air flow rate, but if the air flow rate is too fast, it may easily lead to the same air failing to fully react with the same solid adsorbent in a relatively short period of time, which may cause the carbon dioxide within the air to not be well absorbed by the solid adsorbent, thus affecting the overall adsorption effect of the device.

In order to overcome the problem in the prior art where the flow rate of air passed into the adsorption column cannot be controlled, which affects the overall adsorption effect, a high-pressure air carbon adsorption and desorption integrated device applied to an intelligent greenhouse is provided.

### SUMMARY

One or more embodiments of the present disclosure provide a high-pressure air carbon adsorption and desorption integrated device applied to an intelligent greenhouse, including a first air compressor, a first adsorption column, a second adsorption column, and a vortex blower exhaust pump connected sequentially. A second air compressor is connected to bottoms of the first adsorption column and the second adsorption column, a connecting tube is connected to tops of the first adsorption column and the second adsorption column, and the connecting tube is provided with a high-carbon air outlet; a plurality of groups of adsorption assemblies being arranged at intervals within each of the first adsorption column and the second adsorption column, each group of the plurality groups of adsorption assemblies including two adsorbent placement plates, a heater being arranged between the two adsorbent placement plates, each group of the plurality groups of adsorption assemblies being provided with a plurality of through-holes, and each of the plurality of through-holes being arranged with an openable and closeable variable pressure blade.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an overall structure of an integrated device according to some embodiments of the present disclosure;

FIG. 2 is a schematic diagram illustrating an internal structure of an integrated device according to some embodiments of the present disclosure;

FIG. 3 is a front view illustrating an exemplary integrated device according to some embodiments of the present disclosure;

FIG. 4 is a schematic diagram illustrating an exemplary structure of an adsorption assembly according to some embodiments of the present disclosure;

FIG. 5 is an exploded view illustrating an exemplary adsorption assembly according to some embodiments of the present disclosure;

FIG. 6 is a schematic diagram illustrating an exemplary adsorption phase and desorption phase according to some embodiments of the present disclosure;

FIG. 7 is a flowchart illustrating an exemplary adsorption phase according to some embodiments of the present disclosure;

FIG. 8 is a flowchart illustrating an exemplary desorption phase according to some embodiments of the present disclosure;

FIG. 9 is a module diagram illustrating an exemplary integrated device according to some embodiments of the present disclosure.

Description of the accompanying markings: 1, adsorbent placement plate; 2, heater; 31, first electrically controlled pneumatic valve; 32, second electrically controlled pneumatic valve; 4, carbon dioxide detector; 5, first air compressor; 6, vortex blower exhaust pump; 7, temperature detector; 8, second air compressor; 9, high-carbon air outlet; 91, exhaust fan; 10, first adsorption column; 11, second adsorption column; 12, atomizing nozzle; 13, humidity detector; 14, variable pressure blade; 151, first dust filter screen; 152, second dust filter screen; 161, first air pressure detector; 162, second air pressure detector; 163, third air pressure detector; 17, thermal resistance wire; 18, motor; 19, adjustable voltage regulator; 20, connecting tube; 21, control module.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios according to these drawings without creative labor. Unless obviously obtained from the context or the context illustrates otherwise, the same numeral in the drawings refers to the same structure or operation.

It will be understood that the terms “system,” “engine,” “unit,” “module,” and/or “block” used herein are one method to distinguish different components, elements, parts, sections, or assemblies of different levels in ascending order. However, the terms may be displaced by other expressions if they may achieve the same purpose.

These accompanying drawings are simplified schematic drawings that illustrate the basic structure of the embodiments of the present disclosure in a schematic manner only, and as such they show only the compositions relevant to the embodiments of the present disclosure, and the orientation and references (e.g., up, down, left, right, etc.) may be used only to aid in the description of the features in the accompanying drawings. Accordingly, the following specific embodiments are not employed in a limiting sense.

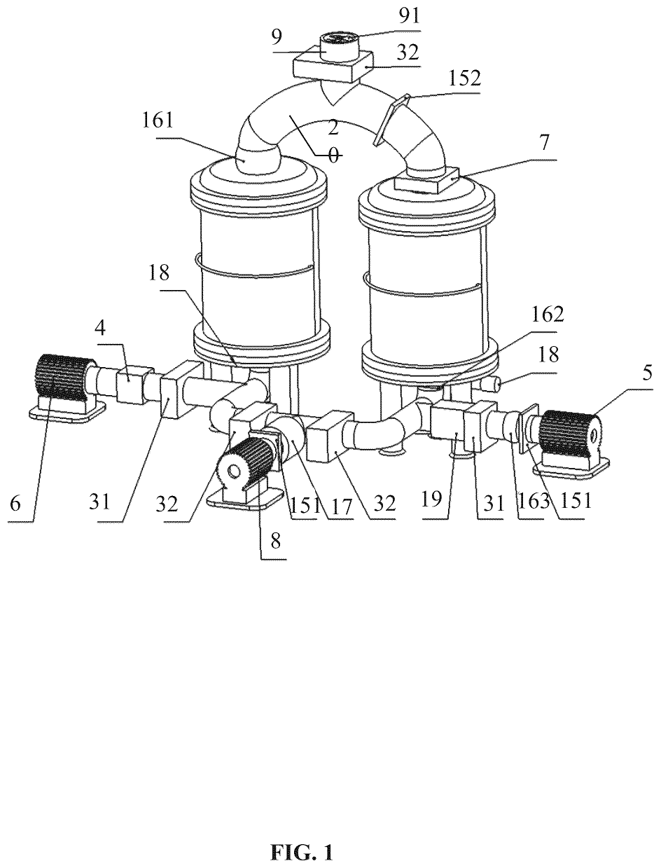

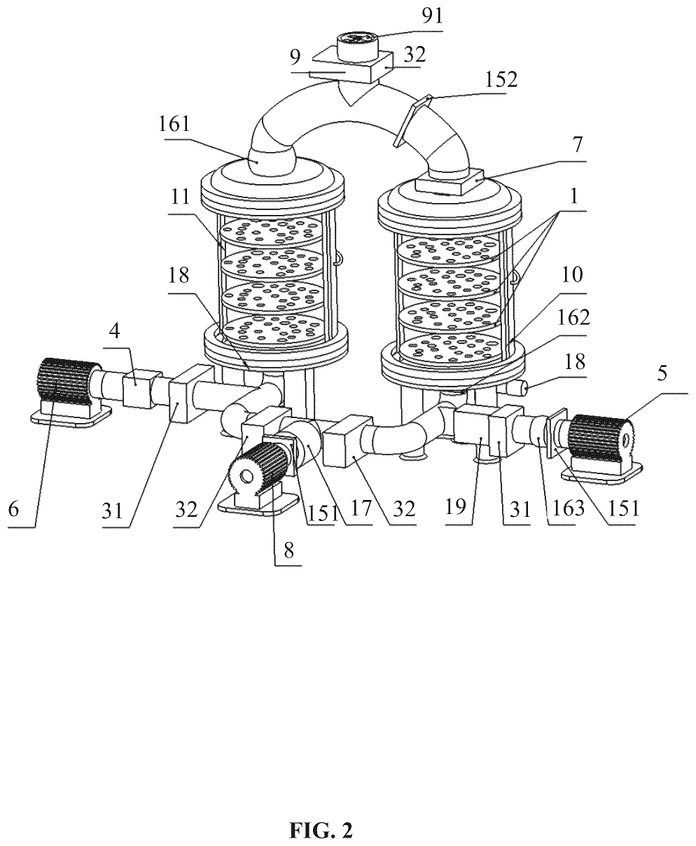

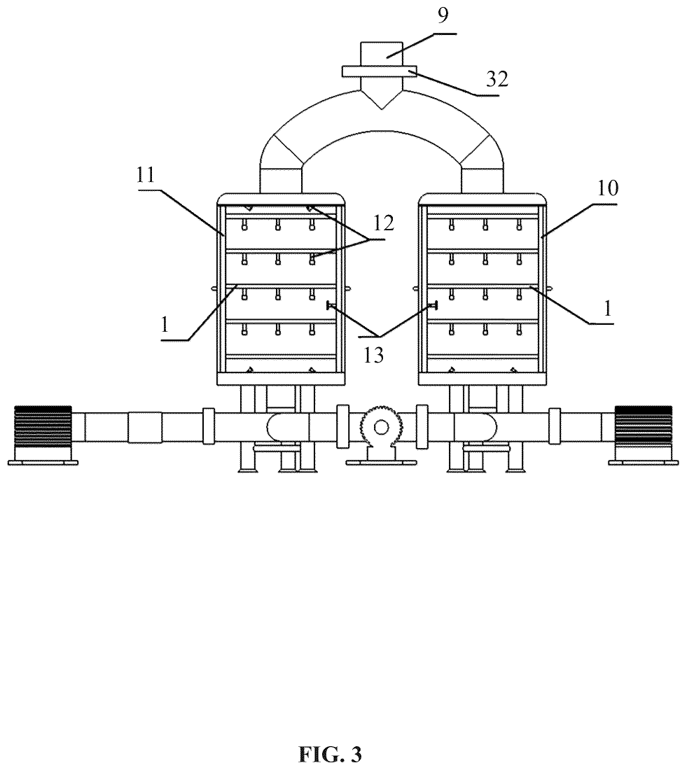

FIG. 1 is a schematic diagram illustrating an overall structure of an integrated device according to some embodiments of the present disclosure; FIG. 2 is a schematic diagram illustrating an internal structure of an integrated device according to some embodiments of the present disclosure; and FIG. 3 is a front view illustrating an exemplary integrated device according to some embodiments of the present disclosure.

As shown in FIGS. 1-3, the present disclosure provides an integrated high-pressure air carbon adsorption and desorption device (hereinafter referred to as the integrated device) applied to smart greenhouses. In some embodiments, the integrated device includes a first air compressor 5, a first adsorption column 10, a second adsorption column 11, and a vortex blower exhaust pump 6 sequentially connected, a second air compressor 8 is connected to bottoms of the first adsorption column 10 and the second adsorption column 11, a connecting tube 20 is connected to tops of the first adsorption column 10 and the second adsorption column 11, and the connecting tube 20 is provided with a high-carbon air outlet 9.

The first air compressor 5 refers to a compressor that compresses air entering the integrated device prior to adsorption. In some embodiments, an air outlet of the first air compressor 5 is connected to the bottom of the first adsorption column 10. The first adsorption column 10 refers to a column assembly that initially adsorbs carbon dioxide from the air. The second adsorption column 11 refers to a column assembly for secondary adsorption of carbon dioxide from the air. In some embodiments, the first adsorption column 10 and the second adsorption column 11 are both placed vertically, as shown in FIG. 1.

The vortex blower exhaust pump 6 refers to an exhaust pump that exhausts the air that has been adsorbed out of the greenhouse. In some embodiments, a bottom of the second adsorption column 11 is connected to an air inlet of the vortex blower exhaust pump 6.

The connecting tube 20 refers to a tube that connects the first adsorption column 10 to an air outlet of the second adsorption column 11. In some embodiments, the connecting tube 20 is curved as shown in FIGS. 1-3.

The second air compressor 8 refers to a compressor that compresses the air entering the integrated device prior to the desorption. In some embodiments, a connecting pipeline between the second air compressor 8 and the first adsorption column 10 and the second adsorption column 11 is in a shape of “Y”. In some embodiments, the power of the first air compressor 5 is greater than the power of the second air compressor 8.

The high-carbon air outlet 9 refers to an air outlet that exhausts air containing high concentrations of carbon dioxide (i.e., high-carbon air) into the greenhouse.

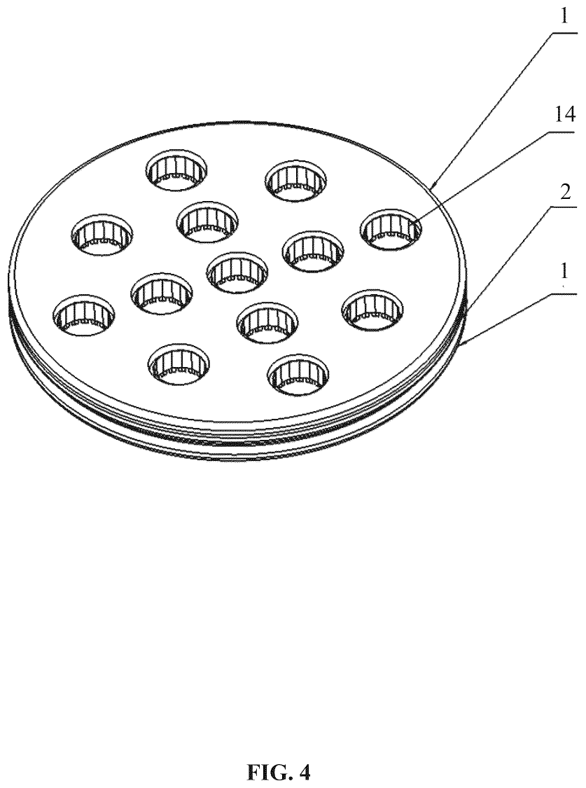

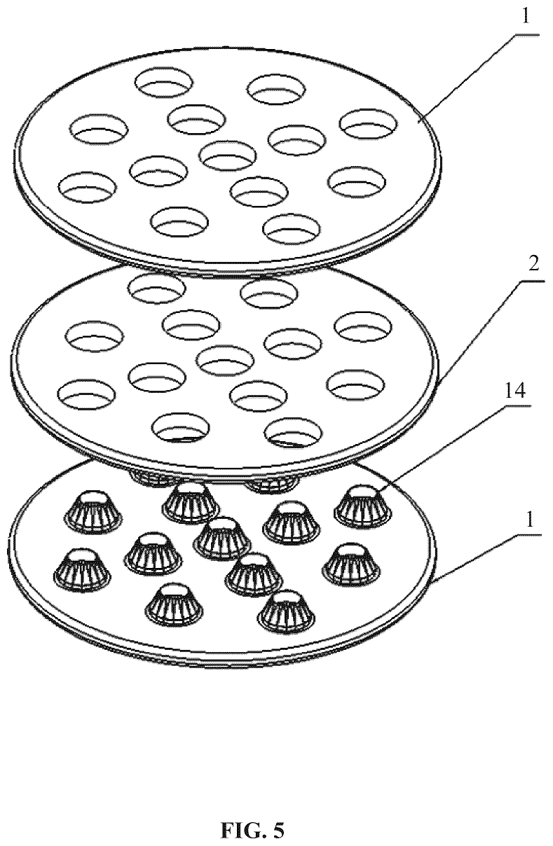

FIG. 4 is a schematic diagram illustrating an exemplary structure of an adsorption assembly according to some embodiments of the present disclosure; and FIG. 5 is an exploded view illustrating an exemplary adsorption assembly according to some embodiments of the present disclosure.

In some embodiments, as shown in FIG. 4 and FIG. 5, a plurality of groups of adsorption assemblies are arranged at intervals within each of the first adsorption column 10 and the second adsorption column 11, each group of the plurality groups of adsorption assemblies includes two adsorbent placement plates 1, a heater 2 is arranged between the two adsorbent placement plates 1, each group of the plurality groups of adsorption assemblies is provided with a plurality of through-holes, and each of the plurality of through-holes is arranged with an openable and closeable variable pressure blade 14.

The variable pressure blade 14 refers to a blade that varies a pressure of air within the adsorption column. In some embodiments, a motor 18 may drive the variable pressure blade 14 to open and close to regulate a size of the through-hole, thereby changing the air flow rate and pressure in the adsorption column, so as to bring the air into full contact with the adsorbent and enhance the carbon adsorption effect per unit time.

The adsorbent placement plate 1 is a placement plate for placing an adsorbent. As shown in FIG. 4, the adsorbent placement plate 1 may be perforated. The adsorbent may be a solid adsorbent, for example, the adsorbent may be activated carbon, zeolite, or the like. In some embodiments, the solid adsorbent is placed between two adjacent sets of adsorption assemblies, i.e., between a lower adsorbent placement plate 1 of the adsorption assemblies located above and an upper adsorbent placement plate 1 of the adsorption assemblies located below.

The heater 2 refers to a component that heats the adsorbent placement plate. In some embodiments, the heater 2 is a graphene heating membrane. By setting the heater 2 to be a graphene heating film, a high thermal conversion rate and uniform heating can be achieved.

In some embodiments, a first electrically controlled pneumatic valve 31 is arranged between the first air compressor 5 and the first adsorption column 10 and between the second adsorption column 11 and the vortex blower exhaust pump 6, and a second electrically controlled pneumatic valve 32 is arranged between the high-carbon air outlet 9, the second air compressor 8, and the first adsorption column 10, and between the second air compressor 8 and the second adsorption column 11, and air on and off may be controlled through the first electrically controlled pneumatic valve 31 and the second electrically controlled pneumatic valve 32.

The first electrically controlled pneumatic valve 31 refers to a valve that opens to allow the air to pass through during the adsorption phase. The adsorption phase refers to a phase in which the adsorption column traps carbon dioxide from the air. The second electrically controlled pneumatic valve 32 refers to a valve that opens to let the air through during the desorption phase. The desorption phase refers to a phase of releasing the carbon dioxide captured in the adsorption phase.

In some embodiments, a humidity detector 13 and a plurality of atomizing nozzles 12 are arranged within each of the first adsorption column 10 and the second adsorption column 11.

The humidity detector 13 refers to a detector that detects a humidity of the air in the adsorption column. The atomizing nozzles refer to nozzles that humidify the air by spraying water mist. In some embodiments, the atomizing nozzles 12 are distributed at a bottom of the first adsorption column 10, at a top and a bottom of the second adsorption column 11, and at a bottom of each adsorption assembly. In some embodiments, the atomizing nozzles 12 are adjustable, and the atomizing nozzles 12 evenly spray water in the adsorption column. On the one hand, the moisture has a ductile effect, which can relatively retain the same air and prolong a reaction time of the same solid adsorbent. On the other hand, the relative humidity of 40% to 60% can accelerate the catalytic reaction of the same air and the same solid adsorbent, which further improves the effect of carbon adsorption and desorption of the high-pressure air per unit of time.

In some embodiments, before the start of the adsorption phase, the atomizing nozzles 12 at the bottoms of the adsorption assemblies perform atomization spraying of water, so that the relative humidity in the adsorption column reaches 50% to 60% in as short a period of time as possible. In the adsorption phase, the atomizing nozzles 12 at the bottom of the first adsorption column 10 and the top of the second adsorption column 11 atomize water spraying at the same time, so that the relative humidity in the whole adsorption column is controlled at 40% to 60%. A direction of the atomized spraying of the atomizing nozzles 12 is the same as a direction of the high-pressure air flow, ensuring that the relative humidity in the adsorption column is kept stable in the process of the adsorption reaction. Finally, before the end of the adsorption phase, a water spray volume of all atomizing nozzles 12 is controlled in advance to reduce the relative humidity in the adsorption column to be controlled in advance to be between 5% and 10%, ensuring the desorption effect of the subsequent desorption phase and enhancing the carbon desorption capability of the integrated device. During the desorption phase, a water spray volume of the atomizing nozzles 12 at the bottom of the first adsorption column 10 and at the bottom of the second adsorption column 11 is adjusted, so as to bring the relative humidity in the adsorption column to be between 5% and 10%, further enhancing the carbon desorption effect.

In some embodiments, the high-carbon air outlet 9 is provided with an exhaust fan 91. The exhaust fan 91 refers to a component that assists the high-carbon air outlet 9 in exhausting high carbon air. When the integrated device is in the desorption phase, the heater 2 in the adsorption column heats the solid adsorbent, and the air in the adsorption column rises by the heat. The exhaust fan 91 cooperates with the second air compressor 8 with a low power, thereby realizing energy saving and avoiding additional energy loss.

In some embodiments, a thermal resistance wire 17 is arranged at an air outlet of the second air compressor 8, and a temperature detector 7 is provided at the top of the first adsorption column 10. At the beginning of the desorption phase, the air passed in is heated in advance, and the heater 2 in the adsorption column only needs to be set to a heating temperature of 70° C. With the thermal resistance wire 17 added to the adsorption column, the adsorption column can reach more than 85° C. in a short time, achieving the carbon dioxide desorption temperature. On the one hand, the heating temperature of the heater 2 is reduced effectively; on the other hand, the preheating and heating time is effectively shortened, thereby improving the carbon desorption effect per unit time of the integrated device.

In some embodiments, a first dust filter screen 151 is arranged at the air outlet of the first air compressor 5 and the second air compressor 8, and a second dust filter screen 152 is arranged between the first adsorption column 10 and the high-carbon air outlet 9. The dust filter screen refers to a filter screen for filtering air impurities. By setting the first dust filter screen 151 and the second dust filter screen 152, impurities can be hindered from entering into the adsorption column and effectively prevented from entering into the greenhouse, avoiding the dust from covering the crops to affect photosynthesis and cause lesions.

In some embodiments, an adjustable voltage regulator 19 is arranged at an air outlet of the first air compressor 5. The adjustable voltage regulator 19 refers to a regulator that regulates the pressure of the air compressed by the first air compressor 5.

In some embodiments, an air pressure detector is provided at the air outlet of the first air compressor 5, at the top of the second adsorption column 11, and at the bottom of the first adsorption column 10. The air pressure detector refers to a detector that detects the pressure of the air. In some embodiments, the air pressure detector includes a first air pressure detector 161, a second air pressure detector 162, and a third air pressure detector 163.

Exemplarily, the third air pressure detector 163 is provided at the air outlet of the first air compressor 5, the first air pressure detector 161 is provided at the top of the second adsorption column 11, and the second air pressure detector 162 is provided at the bottom of the first adsorption column 10. In some embodiments, the second air pressure detector 162 and the third air pressure detector 163 are located on an upstream side and a downstream side of the adjustable voltage regulator 19, respectively. The integrated device may dynamically adjust the pressure of the air passed into the pipeline based on the detection results of the air pressure detector, thereby realizing the dynamic adjustment of the high and low air pressures, and enhancing the effect of high-pressure air carbon adsorption and desorption in a unit time.

According to some embodiments of the present disclosure, the dynamically adjusting the air pressure passed into the pipeline based on detection results of the air pressure detectors may be as follows: when a detection result of the second air pressure detector 162 shows that the air pressure does not reach a preset air pressure, based on a combination of detection results of the second air pressure detector 162 and the third air pressure detector 163, the air pressure passed into the pipeline is adjusted by the adjustable voltage regulator 19 until the air pressure reaches the preset air pressure value as indicated by the detection result of the second air pressure detector 162. The preset air pressure value may be artificially preset.

In some embodiments, a carbon dioxide detector 4 is arranged at an air inlet of the vortex blower exhaust pump 6. The carbon dioxide detector 4 refers to a detector for detecting a carbon dioxide concentration. For example, the carbon dioxide detector 4 may be a carbon dioxide concentration meter, an infrared carbon dioxide detector, a carbon dioxide analyzer, or the like. In some embodiments, when the integrated device is in the adsorption phase, with a frequent use of the solid adsorbent, an adsorption capacity of the solid adsorbent decreases, and the carbon dioxide detector 4 is set up to determine whether the solid adsorbent needs to be replaced with a new solid adsorbent by detecting the carbon content in the discharged air. The design ensures that the carbon capture capacity of the integrated device is stabilized.

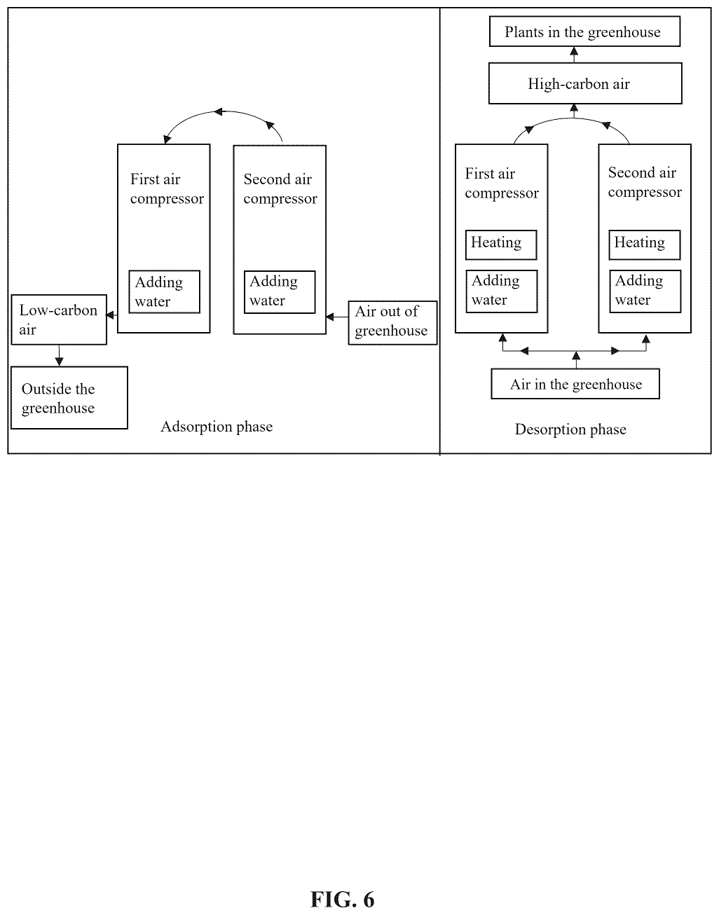

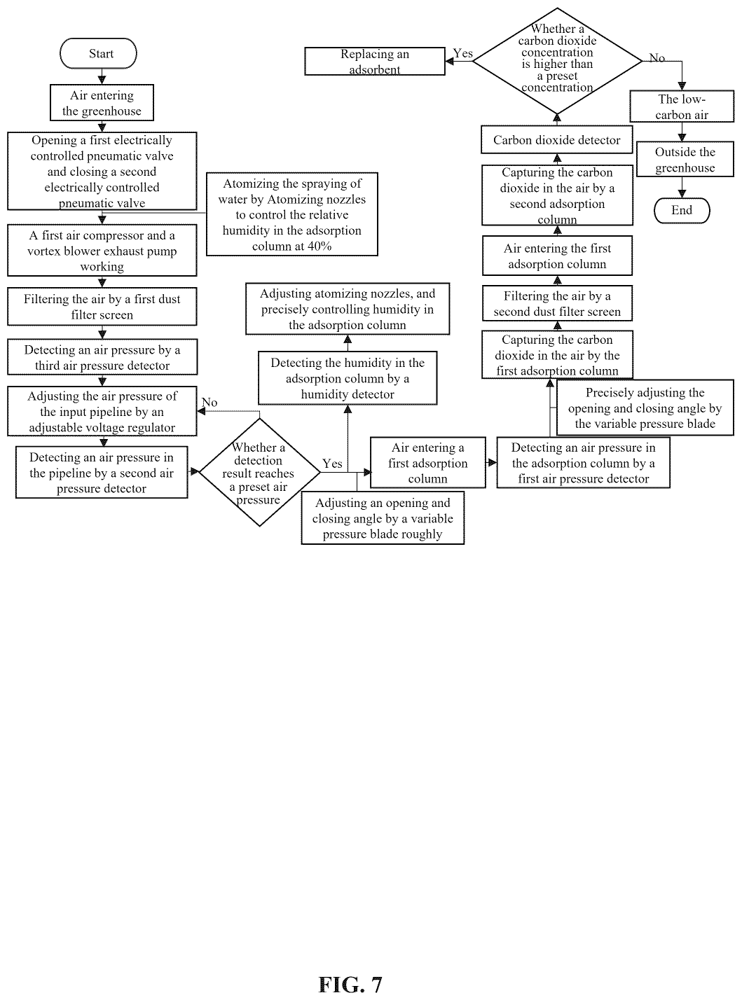

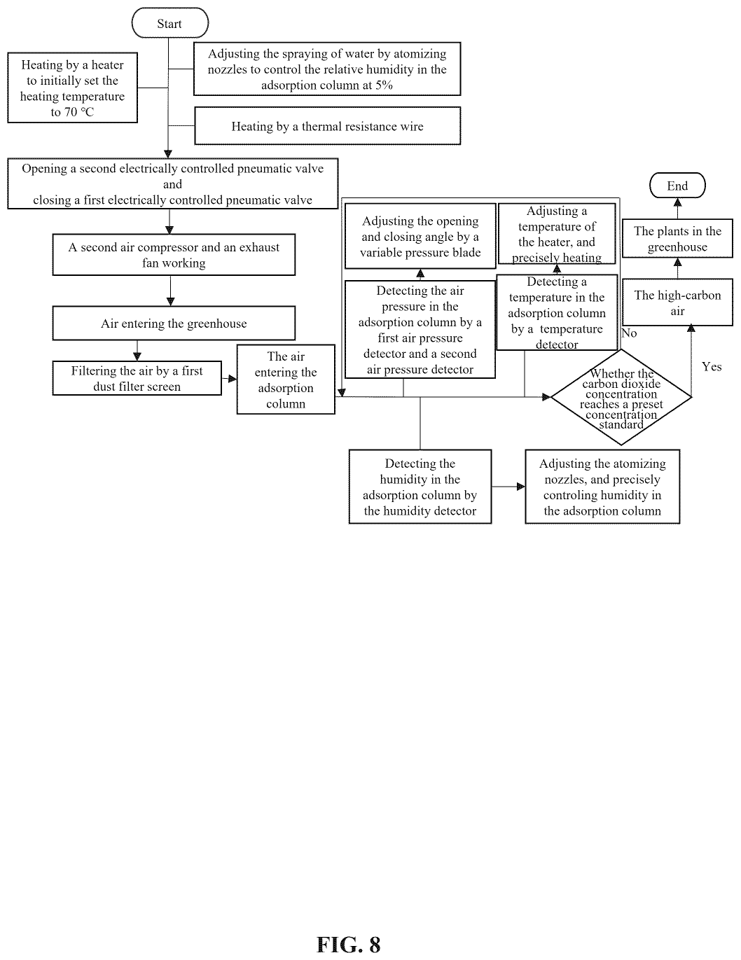

FIG. 6 is a schematic diagram illustrating an exemplary adsorption phase and desorption phase according to some embodiments of the present disclosure; FIG. 7 is a flowchart illustrating an exemplary adsorption phase according to some embodiments of the present disclosure; and FIG. 8 is a flowchart illustrating an exemplary desorption phase according to some embodiments of the present disclosure.

An adsorption-desorption cycle refers to a cycle including the adsorption phase and the desorption phase. Exemplarily, as shown in FIGS. 6-8, a single adsorption-desorption cycle has the following workflow:

First of all, the adsorption phase is performed, the two first electrically controlled pneumatic valves 31 are opened, the three second electrically controlled pneumatic valves 32 are closed, the atomizing nozzles 12 atomize the spraying of water, the humidity detector 13 monitors the humidity in the adsorption column, and the relative humidity in the adsorption column is controlled at 40%. The first air compressor 5 and the vortex blower exhaust pump 6 work to compress air and accelerate the air flow rate within the integrated device, at the same time, making that the high-pressure air passes through the first dust filter screen 151 to filter the air, passes through the third air pressure detector 163, then the air pressure of the input pipeline is adjusted through the adjustable voltage regulator 19, the adjustable voltage regulator 19 is repeatedly adjusted according to whether the detection result of the second air pressure detector 162 reaches the preset air pressure, and then the air is conveyed into the first adsorption column 10. The humidity detector 13 detects the humidity in the adsorption column, adjusts the atomizing nozzles 12 to precisely control the internal humidity, narrows the range of humidity, and through the rough adjustment of the blade opening and closing angle of the variable pressure blade 14, the air enters into the adsorbent placement plate 1 to react with the solid adsorbent. The solid adsorbent captures the carbon dioxide in the air, and the opening and closing angle of the variable pressure blade 14 is precisely adjusted according to the detection result of the first air pressure detector 161. Then, the air filters the air through the second dust filter screen 152 and enters the second adsorption column 11 through the connecting tube 20. The solid adsorbent in the adsorbent placement plate 1 inside the second adsorption column 11 captures the carbon dioxide in the air again. Finally, the low-carbon air is pumped out and discharged outside the greenhouse through the vortex blower exhaust pump 6, during which the carbon dioxide detector 4 continuously detects a carbon dioxide concentration in the low-carbon air. If the carbon dioxide concentration is too high (e.g., the carbon dioxide concentration is higher than a preset concentration), replace the adsorbent.

Then the desorption phase is performed, the atomizing nozzles 12 at the bottom of the adsorption column atomizes water spray volume are adjusted to control the relative humidity in the adsorption column at 5%. Meanwhile, the work of the heater 2 initially sets the heating temperature to 70° C., the thermal resistance wire 17 also begins to heat. Three second electrically controlled pneumatic valves 32 are opened, and two first electrically controlled pneumatic valves 31 are closed. The second air compressor 8 and exhaust fan 91 work to compress air and reduce the air pressure in the adsorption column to draw air in, and the air passes through the first dust filter screen 151 to filter the air, then the air is input into the first adsorption column 10 and the second adsorption column 11 through the “Y” shaped pipeline. The humidity detector 13 detects the humidity in the adsorption column, adjusts the atomizing nozzle 12 to precisely control the humidity in the adsorption column, and uses the temperature detector 7 to detect the temperature in the adsorption column. A temperature of the heater 2 is adjusted to ensure that the temperature in the adsorption column meets the requirements, and the air pressure in the adsorption column is detected by the first air pressure detector 161 and the second air pressure detector 162, the opening and closing angle of the variable pressure blade 14 is adjusted accordingly. The above device may be dynamically adjusted according to the actual situation, allowing for the carbon dioxide to be released from within the solid-state adsorbent. When the optimal desorption effect is achieved (e.g., the carbon dioxide concentration reaches a preset concentration standard), the carbon dioxide released from the solid-state adsorbent is discharged together with the carbon dioxide by an exhaust fan 91 of the high-carbon air outlet 9, so as to discharge air containing a high concentration of carbon dioxide into the greenhouse.

The embodiment of the present disclosure utilizes the first adsorption column and the second adsorption column to prolong the contact time between the solid adsorbent and the air, and utilizes the variable pressure blade to dynamically adjust the blade opening and closing angle to adjust the size of the through-hole and change the air flow rate and the pressure in the adsorption column, making the air and the adsorbent into full contact, thereby improving the carbon adsorption effect per unit time.

The embodiment of the present disclosure utilizes the first adsorption column and the second adsorption column to extend the contact time between the solid adsorbent and the air, and utilizes the variable pressure blade to dynamically adjust the blade opening and closing angle to regulate the size of the through-hole and change the air flow rate and the pressure inside the adsorbent column, ensuring full contact between the air and the adsorbent, which enhances the carbon adsorption effect per unit of time. During photosynthesis of plants in the greenhouse, the passage of high-concentration carbon dioxide air promotes the growth of roots and seedlings of plants in the greenhouse, the thickness of the leaves increases, the transpiration rate is reduced, and the efficiency of water utilization is improved. At the same time, it promotes the growth of the plants, encourages the biosynthesis of ethylene, and enhances the antioxidant capacity of the plants.

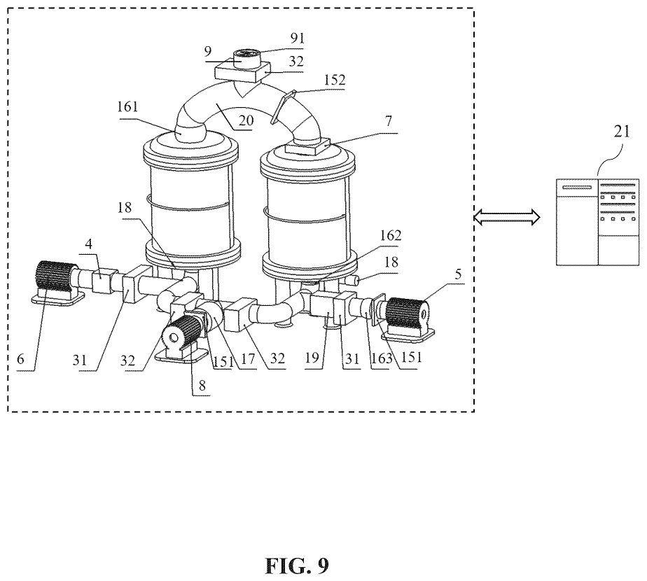

FIG. 9 is a module diagram illustrating an exemplary integrated device according to some embodiments of the present disclosure.

In some embodiments, as shown in FIG. 9, the integrated device further includes a control module 21.

The control module 21 refers to a device or component that processes data and generates instructions, for example, the control module may be a central processing unit (CPU), a graphics processor (GPU), a specialized integrated circuit (ASIC), etc., or any combination thereof. The data may come from different parts of the integrated device or other data sources. The instructions may be sent to different components of the integrated device. In some embodiments, the control module may also comprise other components related to the above, for example, the control module may also be a computer, a server, an industrial control machine, a circuit board with a computational function, or the like. In some embodiments, the control module 21 is communicatively coupled to the components of the integrated device. In some embodiments, the control module 21 is communicatively coupled with a detection device disposed inside the greenhouse, for example, the control module 21 is communicatively coupled with a temperature detector, a humidity detector, an air pressure detector, etc., disposed inside the greenhouse.

In some embodiments, the control module 21 may be configured to: predict carbon adsorption amounts of the first adsorption column and the second adsorption column by a prediction model based on an ambient temperature, ambient humidity, and sensing data; dynamically adjust the blade opening and closing angle of the variable pressure blade 14 and an atomization working parameter of the plurality of the atomizing nozzles 12 based on the carbon adsorption amounts of the first adsorption column 10 and the second adsorption column 11.

The ambient temperature refers to a temperature of an external environment (i.e., greenhouse) in which the integrated device is located. In some embodiments, the control module 21 may obtain the ambient temperature via a temperature detector located inside the greenhouse but not in direct contact with the device.

The ambient humidity refers to humidity of the external environment (greenhouse) in which the integrated device is located. In some embodiments, the control module 21 may obtain the ambient humidity via a humidity detector located inside the greenhouse but not in direct contact with the device.

The sensing data refers to data acquired by a sensing device inside the integrated device. For example, the sensing data may include humidity data, temperature data, barometric pressure data, or the like within the integrated device. In some embodiments, the humidity data may be obtained by the humidity detector 13, the temperature data may be obtained by the temperature detector 7, and the air pressure data may be obtained by the first air pressure detector 161, the second air pressure detector 162, and the third air pressure detector 163.

The carbon adsorption amount refers to an amount of carbon dioxide adsorbed in the adsorbent of the adsorption column.

The prediction model refers to a model for predicting the carbon adsorption amount of the adsorption column. In some embodiments, the prediction model may be a machine learning model. For example, the prediction model may be one of Neural Networks (NN), Deep Neural Networks (DNN), or any combination thereof. In some embodiments, the inputs to the prediction model may include the ambient temperature, the ambient humidity, and the sensing data, and the outputs may be the carbon adsorption amounts of the first adsorption column 10 and the second adsorption column 11, respectively.

In some embodiments, the prediction model may include a first prediction layer that predicts a carbon adsorption amount of the first adsorption column and a second prediction layer that predicts a carbon adsorption amount of the second adsorption column. For example, the inputs of the first prediction layer may include the ambient temperature, the ambient humidity, and the sensing data, and the output of the first prediction layer may be the carbon adsorption amount of the first adsorption column, and the inputs of the second prediction layer may include the ambient temperature, the ambient humidity, the sensing data, and the carbon adsorption amount of the first adsorption column outputted by the first prediction layer, and the output of the second prediction layer may be the carbon adsorption amount of the second adsorption column.

In some embodiments, the first prediction layer may be obtained based on a large number of first training samples trained with first labels. The first training samples and the first labels may be obtained based on historical data. For example, the control module may obtain a plurality of carbon adsorption amounts obtained from a plurality of carbon adsorption amounts conducted historically in the historical data, and generate the first training samples and the corresponding first labels based on the plurality of carbon adsorption amounts, i.e., the control module may designate the ambient temperature, the ambient humidity, and the sensing data corresponding to the plurality of carbon adsorption amounts in the historical data as the first training samples, and the corresponding carbon adsorption amounts as the corresponding first labels.

In some embodiments, the control module 21 may perform a plurality of rounds of iteration, wherein at least one round of iteration comprises: inputting one or more first training samples into an initial first prediction layer, obtaining an output corresponding to the one or more first training samples, substituting an output of the initial first prediction layer with actual corresponding first labels into a predefined loss function, calculating a value of the loss function, and iteratively updating model parameters of the initial first prediction layer based on the value of the loss function, such as updating based on the gradient descent manner; when the value of the loss function satisfies an iteration completion condition, training is completed, and a trained first prediction layer is obtained. The iteration completion condition may include the loss function converging, the count of iterations reaching a threshold, or the like.

In some embodiments, the second prediction layer may be obtained based on a large number of second training samples trained with second labels. The second training samples and the second labels may be acquired based on historical data, which may be described in connection with acquiring the first training samples and the first labels in the preceding section.

The second prediction layer is trained in a similar way to the first prediction layer, which may be found in in the previous descriptions.

In some embodiments, the inputs of the first prediction layer and the inputs of the second prediction layer may also include a current air flow rate. The current air flow rate refers to a current flow rate of air as it flows through the corresponding adsorption column. In some embodiments, the control module 21 may derive the current air flow rate from parameters such as a valve status of the air compressor (e.g., the first air compressor 5 or the second air compressor 8), the electrically controlled pneumatic valve (e.g., the first electrically controlled pneumatic valve 31 or the second electrically controlled pneumatic valve 32). For example, the control module 21 may monitor a current working intensity of the air compressor (e.g., a pressure value) and an opening and closing degree of the valve to estimate the “force” that the air is compressed and pushed and the “resistance” that the air encounters when flowing, and obtain the corresponding air flow rate as the current air flow rate based on the matching of historical data. Exemplarily, the air flow rate is fast when the air compressor is running at high intensity and the valve of the electronically controlled pneumatic valve is wide open; and the air flow rate is slow when the air compressor is running at low intensity and the valve of the electronically controlled pneumatic valve is close.

In some embodiments, when the inputs of the first prediction layer and the inputs of the second prediction layer include the current air flow rate, the first training samples and the second training samples may also include the corresponding sample air flow rate, and the specific training process is similar to that of the first prediction layer, which may be found in the preceding descriptions.

The blade opening and closing angle refers to an angle formed by the variable pressure blade 14 with a plane in which the adsorbent placement plate 1 is located during operation.

The atomization working parameter refers to a parameter related to the spraying of water by the atomizing nozzles 12 during operation. For example, the atomization working parameter may include the water spray volume, a water spray range, a water spray time, etc., of each of the atomizing nozzles 12.

In some embodiments of the present disclosure, the control module 21 may dynamically adjust the blade opening and closing angle of the variable pressure blade 14 and the atomization working parameter of the atomizing nozzles 12 in a variety of ways based on the carbon adsorption amounts of the first adsorption column 10 and the second adsorption column 11. For example, when it is predicted that the carbon adsorption amount of the first adsorption column will preferentially reach a high-carbon load (i.e., an upper limit of the carbon adsorption capacity of the adsorption column is about to be reached), the control module may: control the variable pressure blade 14 to reduce the opening and closing angle and the pressure of the air in the adsorption column, and at the same time increase the water spray volume of each of the atomizing nozzles 12 at the end of the first adsorption column, so as to cause some of the pollutants which have not been adequately processed to enter the second adsorption column in a smaller particulate form; control the second adsorption column to control the variable pressure blade 14 of the second adsorption column to increase the opening and closing angle, and simultaneously increase the water spray volume and the water spray range of each of the atomizing nozzles 12 of the second adsorption column, thereby utilizing the residual adsorption capacity of the second adsorption column to realize secondary capture.

In some embodiments of the present disclosure, by using a prediction model to intelligently predict the working state of the adsorption column, and based on the prediction results, automatically adjusting the blade opening and closing angle and the atomization working parameter, the working loads of the first adsorption column and the second adsorption column are balanced, so that the first adsorption column and the second adsorption column can be able to both efficiently capture pollutants and avoid energy waste.

In some embodiments, an adjustment count of the blade opening and closing angle of the variable pressure blade 14 does not exceed a preset threshold in a single adsorption-desorption cycle, and an interval time between each adjustment is dynamically determined based on a change rate of air pressure within the adsorption column where the variable pressure blade 14 is located.

The preset threshold refers to a threshold associated with the adjustment count of the blade opening and closing angle of the variable pressure blade 14. The preset threshold may be determined by a technician based on historical experience or a prior knowledge.

The change rate of air pressure refers to a change rate of air pressure within the adsorption column. In some embodiments, the control module 21 may obtain the change rate of air pressure by real-time monitoring via the air pressure detector (e.g., the first air pressure detector 161).

In some embodiments, the control module may dynamically determine the interval time between each adjustment in a variety of ways based on the change rate of air pressure within the adsorption column in which the variable pressure blade 14 is located. For example, the interval time for each adjustment may be negatively correlated to the change rate of air pressure, i.e., a fast change rate of air pressure indicates an active adsorption process, and the control module may adjust the opening and closing angle of the variable pressure blade 14 more frequently, i.e., shortening the interval duration for adjustment; when the change rate of air pressure is slow, the control module may reduce the frequency of adjustment, i.e., lengthening the interval time for adjustment, so as to avoid unnecessary loss of the variable pressure blade 14 and save energy.

In some embodiments of the present disclosure, by setting the preset threshold value and dynamically determining the interval time for adjusting the variable pressure blade based on the change rate of air pressure, the wear and tear of the variable pressure blade due to the frequent adjustments of the opening and closing angle can be reduced, and it is possible to ensure the adsorption effect while minimizing the count of adjustments so as to increase the life of the variable pressure blade.

In some embodiments, the blade opening and closing angle of the adsorption phase and the atomization working parameter are correlated to the optimal relative humidity of the adsorption phase.

The optimal relative humidity refers to a relative humidity range of within the adsorption column that is most favorable for adsorbent to adsorb the carbon dioxide.

In some embodiments, the optimal relative humidity may be determined based on historical data. For example, the optimal relative humidity for the adsorption phase may be a relative humidity corresponding to the highest carbon adsorption amount in the adsorption phase in the historical data, and the optimal relative humidity for the desorption phase may be a relative humidity corresponding to the highest carbon dioxide concentration in the air expelled after the desorption phase in the historical data.

In some embodiments, the control module 21 may determine the optimal relative humidity based on the current humidity data, the current heating data, and the current pressure data through the determination layer of the humidity model; based on the ambient temperature, the ambient humidity, and the real-time pressure data through the correction layer of the humidity model, determine the corrected optimal relative humidity.

The humidity model refers to a model for determining the optimal relative humidity. In some embodiments, the humidity model is a machine learning model. For example, the humidity model may be NN, DNN, or the like.

In some embodiments, the humidity model includes a determination layer and a correction layer. The determination layer refers to a layer used to initially determine the optimal relative humidity. The correction layer refers to a layer used to correct the optimal relative humidity.

In some embodiments, the inputs of the determination layer include the current humidity data, the current heating data, and the current pressure data, and the outputs include the optimal relative humidity. The current humidity data refers to data that reflects the current humidity within the adsorption column. The current heating data refers to data that reflects the current temperature in the adsorption column. The current pressure data refers to data that reflects the current air pressure in the adsorption column.

In some embodiments, the current humidity data may be obtained by the humidity detector 13, the current heating data may be obtained by the temperature detector 7, and the current pressure data may be obtained by the air pressure detector (e.g., the first air pressure detector 161).

In some embodiments, the control module 21 may be trained to obtain a determination layer based on a large number of third training samples with third labels.

In some embodiments of the present disclosure, the control module 21 may determine the third training sample and its corresponding third labels from the historical data. For example, the third training sample may include sample humidity data, sample heating data, and sample pressure data from preferred historical data. The third labels may be the optimal sample relative humidity corresponding to the preferred historical data.

The preferred historical data refers to historical humidity data, historical heating data, and historical pressure data corresponding to historical data that makes the carbon adsorption effect or desorption effect great. Exemplarily, the great carbon adsorption effect refers to the carbon adsorption amount in the adsorption phase being greater than a first threshold, and the great desorption effect refers to the carbon dioxide concentration in the air in the desorption phase being greater than a second threshold. The first threshold and the second threshold may be manually preset.

The training operations for the determination layer are similar to the training operations for the prediction model, which may be found in above descriptions.

In some embodiments of the present disclosure, inputs of the correction layer include the ambient temperature, the ambient humidity, and the real-time pressure data, and outputs of the correction layer include corrected optimal relative humidity.

The real-time pressure data refers to data that is instantly available and reflects the current ambient air pressure.

In some embodiments, the real-time pressure data may be measured by the air pressure detector (e.g., the third air pressure detector 163 or an air pressure detector arranged externally to the integrated device).

In some embodiments, the control module 21 may be trained to obtain a correction layer based on a large number of fourth training samples with fourth labels.

In some embodiments, the control module 21 may determine a fourth training sample and its corresponding fourth labels from historical data. For example, the fourth training sample may include a historical preferred ambient temperature, a historical preferred ambient humidity, and historical preferred real-time pressure data from preferred correction data in the historical data. The fourth label may be the best preferred relative humidity corresponding to the combination of the fourth training samples.

The preferred correction data refers to a corrected best preferred relative humidity that satisfies a great effect of carbon adsorption or desorption after correction when the environment changes in the historical data, and the historical preferred ambient temperature, historical preferred ambient humidity, and historical preferred real-time pressure data before the correction.

The training operations for the correction layer are similar to the training operations for the prediction model, which may be found above.

In some embodiments of the present disclosure, the humidity model realizes accurate determination and real-time correction of the optimal relative humidity by making full use of multi-dimensional data such as humidity data, heating data, and pressure data, so as to make the adsorption efficiency higher and the energy consumption lower, and at the same time adapt to different environmental conditions to extend the stable operation time of the equipment.

In some embodiments, the blade opening and closing angle is correlated to the optimal relative humidity in the adsorption phase.

Merely by way of example, when the ambient humidity is less than the optimal relative humidity, the blade opening and closing angle increases, the airflow channel expands, and the longer the moisture stays in the air, the higher the ambient humidity increases. On the contrary, when the ambient humidity is greater than the optimal relative humidity, the blade opening and closing angle decreases, the speed of the airflow becomes faster, the moisture is rapidly taken away, and the ambient humidity decreases.

In some embodiments, the atomization working parameter is related to the optimal relative humidity.

Merely by way of example, when the ambient humidity is less than the optimal relative humidity, the water spray volume of the atomizing nozzles 12 increases, the water spray range becomes larger, and the water spray time becomes longer, the humidification efficiency improves, and the ambient humidity becomes higher. On the contrary, when the ambient humidity is greater than the optimal relative humidity, the water spray volume of the atomizing nozzles 12 decreases, the water spray range becomes smaller, and the water spray time becomes shorter, and the humidification efficiency decreases, and the ambient humidity decreases.

In some embodiments of the present disclosure, by correlating the blade opening and closing angle and the atomization working parameter of the adsorption phase with the optimal relative humidity of the adsorption phase, precise control of the humidity is achieved, thereby improving the carbon dioxide trapping efficiency and the stability of system operation.

The humidity, temperature, and pressure of the air in the adsorption column may affect with each other in some cases, thus affecting the trapping and resolving effect. A relatively higher pressure may be required for rapid adsorption early in the adsorption phase, with gradual adjustments thereafter. While in the desorption phase, a staged warming may be required to gradually release the adsorbate.

In some embodiments, the control module 21 is further configured to: determine optimal temperatures and optimal pressures at a plurality of time points in the adsorption-desorption cycle based on the corrected optimal relative humidity.

The plurality of time points refer to a plurality of time points of different time processes of the adsorption-desorption cycle. In some embodiments, the plurality of time points may include time points selected from early, middle, and late stages of the adsorption-desorption cycle. For example, the control module may select the plurality of time points in the early, middle, and late stages of the adsorption-desorption cycle, respectively, based on a preset interval time. The preset interval time may be preset based on experience.

The optimal temperature refers to temperature data in the adsorption column corresponding to the best carbon adsorption or desorption at different time processes.

The optimal pressure refers to pressure data in the adsorption column corresponding to the best carbon adsorption or desorption at different time processes.

In some embodiments, the control module 21 may determine an optimal temperature and an optimal pressure at the plurality of time points in the adsorption-desorption cycle in a plurality of ways based on the corrected optimal relative humidity. For example, the control module 21 may determine, based on a current corrected optimal relative humidity, an optimal temperature and an optimal pressure for the current time point by consulting a first preset table, and based on the optimal temperatures and the optimal pressures, adjust the heater 2 and the adjustable voltage regulator 19 until the optimal temperature and optimal pressure are reached within the adsorption column, which process may be carried out at the preset interval time. The first preset table includes a correspondence of the optimal relative humidity with the optimal temperature and the optimal pressure, which may be preset by a technician based on historical data and experience.

In some embodiments of the present disclosure, the optimal temperatures and the optimal pressures at the plurality of time points in the adsorption-desorption cycle are dynamically determined based on the corrected optimal relative humidity, and the temperature and pressure can be dynamically adjusted according to the changes in the optimal relative humidity to ensure the efficient operation of each stage, realizing precise control of key process parameters, significantly improving the efficiency of equipment operation, and ensuring the performance of the adsorption phase and the desorption phase.

In some embodiments of the present disclosure, the control module 21 is further configured to: determine the water spray volume of the atomizing nozzles 12 later in the adsorption phase based on a target humidity range for the desorption phase.

The target humidity range refers to an engineering allowable range based on the optimal relative humidity. For example, the target humidity range may be a humidity range of the optimal relative humidity combined with safe redundancy (e.g., +5%). Exemplarily, the optimal relative humidity is 10%, and the target humidity range may be set from 5% to 15% for actual operation.

In some embodiments, the control module 21 may determine the water spray volume of the atomizing nozzles 12 in a later stage of the adsorption phase in a variety of ways based on the target humidity range for the desorption phase. For example, when the target humidity range of the desorption phase is 5%-15%, the control module 21 may control the humidity to 5%-15% in advance by adjusting the water spray volume of the atomizing nozzles 12 prior to the end of the adsorption phase.

In some embodiments of the present disclosure, by determining the water spray volume of the atomizing nozzle in advance in the later stage of the adsorption phase, the humidity in the adsorption column can be controlled in advance in the target humidity range required in the desorption phase, ensuring the desorption effect in the subsequent desorption phase and enhancing the carbon desorption capability of the device.

In some embodiments, the atomizing nozzles 12 activate a drying mode before the end of the adsorption phase and shut off after adjusting the relative humidity within the adsorption column where the atomizing nozzles 12 are located to a target humidity range.

The drying mode refers to a mode which ensures that the adsorption column is within a suitable condition by adjusting the humidity within the adsorption column to the target humidity range.

In some embodiments, the control module 21 may adjust the relative humidity within the adsorption column to the target humidity range by adjusting the atomization working parameter of the atomizing nozzle 12 under the drying mode. For example, the higher the degree to which the relative humidity exceeds the highest value of the target humidity range, the faster the control module 21 may reduce the water spray volume by the atomizing nozzles 12, the shorter the water spray time, and the atomizing nozzles 12 may be turned off until the relative humidity reaches the target humidity range.

It should be noted that since the target humidity ranges of the first adsorption column 10 and the second adsorption column 11 are not necessarily the same, the first adsorption column 10 and the second adsorption column 11 need to carry out the above mentioned adjusting process separately.

In some embodiments of the present disclosure, by activating the drying mode before the end of the adsorption phase, the relative humidity in the adsorption column is regulated, and the atomizing nozzles are timely turned off after the target humidity range is reached, ensuring that the respective adsorption columns are in the target humidity range to ensure the desorption effect of the subsequent desorption phase.

In some embodiments, the control module 21 may also obtain carbon dioxide data based on the carbon dioxide detector 4; verify the accuracy of the prediction model based on the carbon dioxide data; and dynamically correct the blade opening and closing angle and the atomization working parameter based on the carbon dioxide data.

More descriptions regarding the prediction model may be found in the related descriptions above.

The carbon dioxide data refers to data reflecting the concentration of carbon dioxide at the air inlet of the vortex blower exhaust pump 6.

In some embodiments, the control module 21 may obtain the carbon dioxide data via the carbon dioxide detector 4.

In some embodiments, the control module 21 may validate the accuracy of the prediction model in a variety of ways based on the carbon dioxide data. For example, the carbon dioxide detector 4 may monitor the carbon dioxide concentration at the air inlet of the vortex blower exhaust pump 6 in real-time, and the decrease in the carbon dioxide concentration is indicative of the increase in the carbon adsorption amount; as a result, the control module 21 may incorporate the air flow rate to reverse calculate the actual carbon adsorption amount.

Exemplarily, when the difference between the output of the prediction model and the actual calculated carbon adsorption amount exceeds a difference threshold, the control module 21 may determine that the prediction model is inaccurate and the prediction model needs to be retrained; and when the difference between the output of the prediction model and the actual calculated carbon adsorption amount dose not exceeds the difference threshold, the control module 21 may determine that the prediction model is accurate. The difference threshold refers to a threshold associated with the difference between the output of the prediction model and the actual calculated carbon adsorption amount, and the difference threshold may be preset based on historical experience.

In some embodiments, the control module 21 may dynamically correct the blade opening and closing angles and the atomization working parameter based on the carbon dioxide data.

For example, when the carbon dioxide data is elevated, indicating that the adsorption effect is reduced, the control module 21 may increase the blade opening and closing angle and adjust the water spray volume, the water spray range, and the water spray time of each of the atomizing nozzles 12; when the carbon dioxide data is reduced, the control module 21 may reduce the blade opening and closing angle, and maintain the water spray volume, the water spray range, and the water spray time of each of the atomizing nozzles 12.

In some embodiments of the present disclosure, by verifying the accuracy of the prediction model and closed-loop optimization of the prediction model, the adsorption efficiency can be balanced with the energy consumption to ensure that the entire adsorption phase is always in an optimal working condition.

The above ideal embodiments based on the present disclosure are revelation, and by means of the above described contents, the relevant staff is fully capable of carrying out diversified changes as well as modifications within the scope of the technical ideas of the present disclosure without departing from it. The technical scope of this disclosure is not limited to the above, but must be determined by the scope of the claims.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A high-pressure air carbon adsorption and desorption integrated device applied to an intelligent greenhouse, comprising a first air compressor, a first adsorption column, a second adsorption column, and a vortex blower exhaust pump connected sequentially, wherein a second air compressor is connected to bottoms of the first adsorption column and the second adsorption column, a connecting tube is connected to tops of the first adsorption column and the second adsorption column, and the connecting tube is provided with a high-carbon air outlet;
a plurality of groups of adsorption assemblies are arranged at intervals within each of the first adsorption column and the second adsorption column, each group of the plurality groups of adsorption assemblies including two adsorbent placement plates, a heater being arranged between the two adsorbent placement plates, each group of the plurality groups of adsorption assemblies being provided with a plurality of through-holes, and each of the plurality of through-holes being arranged with an openable and closeable variable pressure blade.

2. The device according to claim 1, wherein a humidity detector and a plurality of atomizing nozzles are arranged within each of the first adsorption column and the second adsorption column.

3. The device according to claim 1, wherein the high-carbon air outlet is arranged with an exhaust fan.

4. The device according to claim 1, wherein a thermal resistance wire is arranged at an air outlet of the second air compressor, and a temperature detector is provided at a top of the first adsorption column.

5. The device according to claim 1, wherein a first dust filter screen is arranged at air outlets of the first air compressor and the second air compressor, and a second dust filter screen is arranged between the first adsorption column and the high-carbon air outlet.

6. The device according to claim 1, wherein a first electrically controlled pneumatic valve is arranged between the first air compressor and the first adsorption column and between the second adsorption column and the vortex blower exhaust pump, and a second electrically controlled pneumatic valve is arranged between the high-carbon air outlet, the second air compressor, and the first adsorption column, and between the second air compressor and the second adsorption column.

7. The device according to claim 1, wherein an adjustable voltage regulator is arranged at an air outlet of the first air compressor, and air pressure detectors are arranged at the air outlet of the first air compressor, a top of the second adsorption column, and a bottom of the first adsorption column.

8. The device according to claim 1, wherein a carbon dioxide detector is arranged at an air inlet of the vortex blower exhaust pump.

9. The device according to claim 1, wherein the heater is a graphene heating film.

10. The device according to claim 2, wherein the device further includes a control module, the control module is configured to:
predict carbon adsorption amounts of the first adsorption column and the second adsorption column by a prediction model based on an ambient temperature, ambient humidity, and sensing data; the prediction model being a machine learning model; and
dynamically adjust a blade opening and closing angle of the variable pressure blade and an atomization working parameter of the plurality of atomizing nozzles based on the carbon adsorption amounts of the first adsorption column and the second adsorption column.

11. The device according to claim 10, wherein an adjustment count of the blade opening and closing angle of the variable pressure blade does not exceed a preset threshold in a single adsorption-desorption cycle, and an interval time between each adjustment is determined dynamically based on a change rate of air pressure within an adsorption column in which the variable pressure blade is located.

12. The device according to claim 10, wherein the blade opening and closing angle and the atomization working parameter in an adsorption phase are correlated to an optimal relative humidity in the adsorption phase.

13. The device according to claim 12, wherein the control module is further configured to:
determine, based on current humidity data, current heating data, and current pressure data, through a determination layer of a humidity model, the optimal relative humidity; and
determine a corrected optimal relative humidity based on the ambient temperature, the ambient humidity, and real-time pressure data through a correction layer of the humidity model; the humidity model being a machine learning model.

14. The device according to claim 13, wherein the control module is further configured to:
determine optimal temperatures and optimal pressures at a plurality of time points in the adsorption-desorption cycle based on the corrected optimal relative humidity.

15. The device according to claim 10, wherein the control module is further configured to:
determine a water spray volume of each of the plurality of atomizing nozzles in a later stage of an adsorption phase based on a target humidity range in a desorption phase, the target humidity range being determined based on an optimal relative humidity in the desorption phase.

16. The device according to claim 2, wherein the plurality of atomizing nozzles activate a drying mode before an end of an adsorption phase, and turn off the drying mode after adjusting a relative humidity within an adsorption column where the plurality of atomizing nozzles are located to a target humidity range.

17. The device according to claim 8, wherein the device further comprises a control module, the control module is configured to:
predict carbon adsorption amounts of the first adsorption column and the second adsorption column by a prediction model based on ambient temperature, ambient humidity, and sensing data, the prediction model being a machine learning model;
dynamically adjust a blade opening and closing angle of the variable pressure blade and an atomization working parameter of the plurality of atomizing nozzles based on the carbon adsorption amounts of the first adsorption column and the second adsorption column;
obtain carbon dioxide data based on the carbon dioxide detector;
verify an accuracy of the prediction model based on the carbon dioxide data; and
dynamically correct the blade opening and closing angle and the atomization working parameter based on the carbon dioxide data.
